(19) United States
(12) Patent Application Publication
(10) Pub. No.: US 2016/0063980 A1
(43) Pub. Date: Mar. 3, 2016

(54) ELECTRONIC MUSIC INSTRUMENT AND METHOD FOR CONTROLLING AN ELECTRONIC MUSIC INSTRUMENT

(71) Applicant: NATIVE INSTRUMENTS GmbH, Berlin (DE)

(72) Inventor: Matthias BUESE, Berlin (DE)

(21) Appl. No.: 14/474,506

(22) Filed: Sep. 2, 2014

(51) Int. Cl. G10H 1/34

(52) U.S. Cl. CPC G10H 1/344

(57) ABSTRACT

An electronic music instrument comprises a keyboard having a plurality of keys configured for generating a digital signal corresponding to a particular note when pressed; and a software module, wherein the software module is configured for receiving the digital signal and for including a play assistant module, wherein the play assistant module is configured for setting at least one element of the group consisting of a desired root note and a desired scale and further configured for remapping the note of the digital signal to the set element.

The present invention relates to an electronic music instrument, a method for controlling an electronic music instrument, a computer program and a computer-readable storage medium.

Keyboard instruments and their corresponding software provide so-called play assistants to enhance the player's comfort. These are software modules that intercept or influence the MIDI (Musical Instrument Digital Interface) digital signals or note events generated by the player on the keyboard's keybed and alter the event stream in such a way that the player can achieve musically complex playing styles while not having to be an expert musician, e.g. harmonizing the played notes or arpeggiation of notes.

A so-called scale mode is known from Apple's GarageBand App for the iPad. The app shows a Marimba-like interface to the user, excluding notes that don't fit a certain scale and root note setting. In particular the black keys are suppressed and not depicted on the screen. The black keys are also called intermediate semitones. In the scale mode, when connecting a standard MIDI keyboard to the iPad, all keys are, however, functioning normally.

Thereby arises the problem that this play assistant can not be integrated into a professional environment with components like a MIDI keyboard or a digital audio workstation.

This problem is solved according to the invention by an electronic music instrument according to claim 1, a method for controlling an electronic music instrument according to claim 10, a computer program according to claim 16 and a computer-readable storage medium according to claim 17, respectively.

According to an aspect of the present invention an electronic music instrument comprises a keyboard having a plurality of black and white keys configured for generating at least one digital signal corresponding to a particular note when pressed; and a software module, wherein the software module is configured for receiving the digital signal and for including a play assistant module, wherein the play assistant module is configured for remapping the note of the digital signal according to at least one element of the group consisting of a desired root note and a desired scale and further configured for discarding digital signals generated by black keys. This play assistance module can be termed as the so-called white key mode. The player or another instance like for example a digital audio workstation can select a certain desired root note and/or scale in the play assistant module. Then, by playing a simple C-Major scale on the keys the events get remapped to sound in the set or pre-selected scale and/or root note. At the same time, the black keys are deactivated for play, i.e. for producing sounds. This mode is especially useful to novice keyboard players that are not savvy in automatically transposing between scales and different root notes. They can simply play the white keys they are used to but the sounding notes can fit to complicated musical styles.

The electronic instrument can be arranged in a single housing like a keyboard instrument or a synthesizer. It is also possible that the electronic instrument is distributed over more devices or elements like for example a hardware keyboard and a computer on which the software module is executed. The software module as well as the play assistant module can be a plugin or instrument running on computational hardware.

The software module may be a software synthesizer. As the synthesizer generates the electric sound signals or waveforms it is advantageous to include the remapping of the control keys into the software synthesizer. In this way, the necessary calculations can be performed more efficiently.

The desired root note may be mapped to the C4 key. The major scale C is usually the scale which novice keyboard players can play. So, they can simply play the white keys they are used to which is mostly the simple Do-Re-Mi C-Major scale. The sounding notes however can fit to complicated musical styles.

The electronic music instrument may further comprise visual indicators each arranged at a key and configured for indicating at least one element of the group consisting of a desired root note and a desired scale. By looking at the keys of the keyboard in front of him the player can see which keys are used by the play assistant module. The visual indicators like LEDs provide visual feedback of the currently selected root note and scale. The player's experience is greatly enhanced as the play assistant functions are directly evident from the keyboard. No looks towards a control screen of a computer or the like are necessary to assess the status of the play assistant functions.

The electronic music instrument may further comprise visual indicators each arranged at a key and configured for indicating where the next root note is located on the keyboard. The indication of the so-called wrapping informs the player where the next root note is located. The wrapping of the scale means: that is if the selected scale is composed of more or less notes than the eight white keys representing the C-Major scale on a piano keyboard, the next root note will be not mapped to the next C key (where in the C-Major scale the wrapping takes place). In this case the one or more LEDs indicate the key at which the wrapping takes place. It can also be advantageous to show the wrapping in any case, i.e. as well when the next root note will be mapped to the next C key.

The electronic music instrument may further comprise an RGB LED for each key, the RGB LEDs being configured for color coding the indication of the desired root note and the desired scale. The color coding adds a further step in convenience for the player. With one view the player can identify the root note (e.g. blue) and the scale or next root note in another color (e.g. red). This enhanced play assistant visualization enables the player to perform without having to memorize the play assistant's mapping. Further, the colors of the keys can be matched with screen representations of software for example of a digital audio workstation.

The electronic music instrument may further comprise visual indicators each arranged at a key and configured for being adapted according to at least one parameter of the group of hue, saturation and brightness. These parameters offer a wide range of presentation or display for coding the keys of the keyboard.

The keyboard may be configured to be organized in sounding keys and non-sounding control keys and the software module may be configured for excluding control keys from being processed by play assistant functions and for excluding play assistant functions from generating control key events. Then, control keys for setting and influencing the instrument's behavior are passed unprocessed through the play assistant module or function. In other words, the key range of the control keys is excluded from the event generation in the play assistant function. This way, a state change of the instrument is not accidentally triggered. At the same time the intended state change induced by operation of a control key can not trigger the play assistant module and generate audible events. In other words, when an instrument marks certain MIDI notes as control notes, the respective keys are excluded from the white key mode, therefore enabling the user to still control the instrument's parameters. All black keys have no functioning in the white key mode, except when they have a control functioning. Hence, it is prevented that a play assistant function is induced by a control key which would generate an undesired key event. It is also prevented that a play assistant function generates a control key thereby generating an undesired key event. As a result, the play assistant function and the control function are functionally separated in order to prevent undesired state change if the instrument. This separation may be achieved for example with a list of control keys which is matched against a pressed key or by an arbitrator supervising the play assistant function and the control function.

The software module may be configured for not discarding black keys assigned as control keys. This way, the player can concentrate on the white keys thereby easing play. All black keys also called intermediate semitones keys have no functioning in the white key mode, except when they have a control functioning. Only the natural notes of the white keys generate sounding notes when pressed. The black keys are treated like non-sounding keys. While the black keys are discarded or disregarded by the play assistant module or play assistant functions, black keys being control keys can be considered or processed by other instances like the software module.

According to another aspect of the present invention a method for controlling an electronic music instrument having a keyboard with a plurality of white keys and black keys configured for generating at least one digital signal corresponding to a particular note when pressed, includes remapping the note of the digital signal according to at least one of a desired root note and a desired scale and discarding digital signals generated by black keys. As described above, the so-called white key mode allows playing of complex music styles or cooperative playing for novice players by remapping the played white key to a desired root note and/or desired scale which has been set and by suppressing the sounding from black keys. This way, the novice player can easily orientate himself on the keyboard. Black keys of the keyboard are not used for actual playing the instrument. The black keys may be used for controlling the instrument or its behavior. The reduction to the white keys is a helpful simplification for novice players.

At least one element of the group consisting of a desired root note and a desired scale may be visually indicated at a key. Such a visual indication allows for a quick orientation of the instrument's or keyboard's set up.

The visual indication at a key may be adaptable by at least one parameter of the group of hue, saturation and brightness. These parameters offer a wide range of presentation or display for coding the keys of the keyboard.

An RGB LED may be provided for each key and an indication of the desired root note and the desired scale may be color coded by the RGB LEDs. The color coding facilitates handling of the instrument even more as the root note and the scale may correspond to different colors. The range of displayed colors is not limited to the colors red, green or blue as emitted by the exemplary RGB LED. The full gamut of colors can be utilized for coding the keys.

The control keys may be excluded from play assistant functions in order to prohibit erroneous operation of the instrument. By excluding the control keys from play assistant functions it is ensured that one key does not belong to different functionalities, i.e. the control function and the play assistant function. Separating these functions prevents unwanted states of the instrument or of the functions.

Black keys assigned as control keys may not be discarded. Black keys of the keyboard may be used for controlling the instrument or its behavior, while they still have no sounding function.

According to a further aspect of the present invention a computer program which enables a data processing device, after the computer program has been loaded into memory means of the data processing device, to carry out a method as described above. Such a computer program may be provided for downloading in a data or communication network. The computer program may be downloaded via the internet to computer like for example a digital audio workstation (DAW).

According to an even further aspect of the present invention a computer-readable storage medium on which a program is stored which enables a data processing device, after the program has been loaded into memory means of the data processing device, to carry out a method as described above.

Exemplary embodiments of the invention will now be described in more detail with reference to the Figures which show in

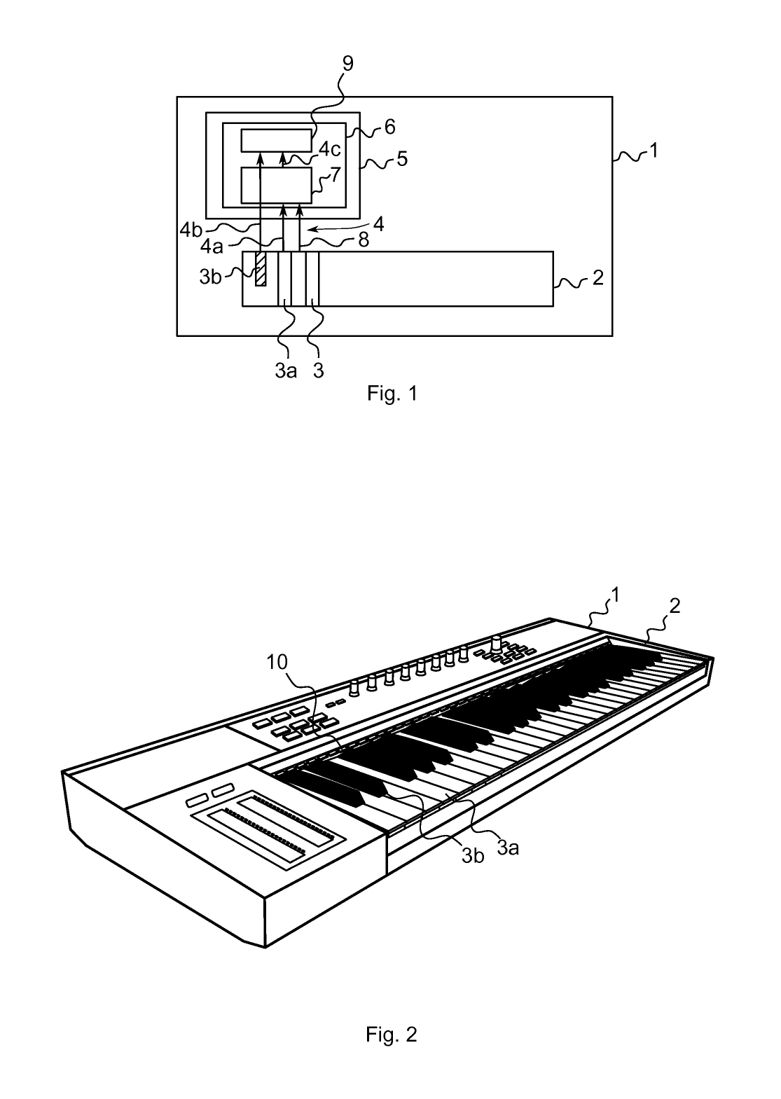

FIG. 1 a schematic diagram of the electronic music instrument; and

FIG. 2 a spatial representation of the electronic music instrument.

FIG. 1 shows an electronic music instrument 1 as a block diagram. The electronic music instrument 1 may be a keyboard instrument or synthesizer. Accordingly the instrument 1 has a hardware keyboard 2 with a plurality of keys 3. For the ease of understanding only a few keys 3 are depicted here. By way of example one white key 3a and one black key 3b is shown. The white key 3a belongs to one of the natural notes C, D, E, F, G, A, and B. The black key 3b can also be called intermediate semitone. The keyboard 2 may for example include 25, 49 or 61 keys.

Each key 3a and 3b generates a signal when it is pressed by a player. Via a communication link 4 like a data line or a bus system the signal is provided to a data processing device 5. The data processing device 5 may be a chip or the like in an enclosure common to the keyboard 2 or a separate device like a computer or a digital audio workstation (DAW). The signal, the communication link 4, protocols and/or interfaces may be compatible to the MIDI (Musical Instrument Digital Interface) standard.

The data processing device 5 runs or executes a software module 6 to which the signal is provided. The software module 6 encompasses further modules, routines, functions or plugins like for example one or more play assistance functions and/or a collection of instrument plugins. Here, a play assistance module 7 is present which can be referred to as a white key mode.

In order to set or activate the white key mode or the play assistance module 7 at least one element 8 of the group consisting of a desired root note and a desired scale is provided from the keyboard 2 to the play assistance module 7. The desired root note like for example A, i.e. an A4 of the one-line octave and/or a desired scale like for example minor can be input by the player via the keyboard 2 or by encoders, computer screens or further control elements. The desired settings can optionally inputted into the play assistance module 7 or the software module 6 by another instance like for example a software routine, another instrument or a digital audio workstation like the data processing device 5.

During play of the keyboard 2 and the previously described settings pressing the C3 white key white key generates a digital signal 4a corresponding to a certain note like for example a A4, i.e. an A of the one-line octave. This digital signal 4a is provided via the communication link 4 to the data processing device 5 and to the software module 6. Inside the software module 6 the signal 4a is directed towards the play assistance module 7.

In the play assistance module 7 the note of the digital signal 4a is remapped to the set element. The set element 8 corresponds to the desired root note and/or the desired scale. In this example, the played key or note C3 is remapped to the desired note A4. While playing the same keys the play assistance module 7 remaps the corresponding notes to the ones of the desired root note and/or the desired scale. This allows the player to play pieces or styles of music which are not playable for him without the support of the play assistance module 7.

The play assistance module 7 outputs the remapped signal or note as a sounding signal or note 4c to an output module 9. According to the sounding signal 4c the output module 9 generates or computes an output signal to be recorded and or played. The sounding signal 4c may be further influenced by internal and/or external modulation engines, oscillators, sequencers, envelope followers or the like.

When a black key 3b is pressed during play a digital signal 4b is generated and provided via the communication link 4 to the data processing device 5 and to the software module 6. In the white key mode of the play assistance module 7 signals 3b of the black keys are not outputted as a sound by the instrument 1. The signals 3b are passed unaltered through the play assistance module 7 into the output module 9 or the software module 6. When a black key 3b is set as a control key control functions or parameters of the instrument 1, the keyboard 2, the data processing device 5, the play assistance module 7, the output module 9 and/or the software module 6 are altered or set.

According to FIG. 2 an embodiment of the instrument 1 is shown. Here, the data processing device (not shown) is integrated in the same housing with the keyboard 2. To each key 3a and 3b a visual indicator 10 is assigned. The visual indicators 10 are arranged directly at the respective keys 3a and 3b. Here, the visual indicators 10 are located at ends of the keys distant to a player. In other words, the visual indicators 10 are arranged in the vicinity to the pivot of the keys 3a and 3b. As an alternative the keys 3a and 3b itself may be illuminated. The visual indicators can be present in the embodiment of FIG. 1 as well.

The visual indicator 10 may include a light emitting diode (LED) advantageously an RGB LED capable of displaying red, green and blue light. An LED can be directly arranged at a key 3a and 3b or inside the instrument 1. In latter case a light guide is present guiding the light to a display element in front of the key 3a and 3b.

The visual indicator 10 indicates information with regard to the respective key 3a and 3b. The visual indicator 10 shows which key 3a is set as the desired root note which is the C4 note in this example. Another visual indicator 10 may optionally indicate the key 3a to be played which is the A4 note in this example. The two mentioned visual indicators 10 may use different colors.

The visual indicator 10 may further indicate the wrapping of the desired scale. If the selected scale is composed of more or less notes than the 8 white keys representing the C-Major scale on a piano keyboard, the next root note will be not mapped to the next C key. Instead, the next root note will be mapped to a key left or right to the next C key depending on the number of notes of the desired scale. The visual indicator 10 may indicate the key at which the wrapping takes place, i.e. at which key the next root note is located.

The visual indicators 10 may be located only at white keys 3a as only these keys are active during the white key mode. However, the black keys 3b or one or more of the black keys 3b can be used as non-sounding control keys. By pressing a sounding key, i.e. a white key 3a the signal 4a corresponding to a note or a sequence of notes is generated by the keyboard 2. By pressing a non-sounding control key 3b control functions or parameters are altered or set.

The possibility to map certain keys to a different desired root note and/or desired scale allows a less adept player to play pieces or styles of music that could otherwise not be mastered by the player. The reduction to the white keys 3a further eases play of the instrument 1 for a novice player.

1. An electronic music instrument, the instrument comprising
a keyboard having a plurality of black and white keys configured for generating at least one digital signal corresponding to a particular note when pressed; and
a software module, wherein the software module is configured for receiving the digital signal and for including a play assistant module, wherein the play assistant module is configured for remapping the note of the digital signal according to at least one element of the group consisting of a desired root note and a desired scale and further configured for discarding digital signals generated by black keys.

2. The electronic music instrument according to claim 1, wherein the software module is a software synthesizer or sample-based instrument.

3. The electronic music instrument according to claim 1, wherein the desired root note is mapped to the C4 key.

4. The electronic music instrument according to claim 1, further comprising visual indicators each arranged at a key and configured for indicating at least one element of the group consisting of a desired root note and a desired scale.

5. The electronic music instrument according to claim 1, further comprising visual indicators each arranged at a key and configured for indicating where the next root note is located on the keyboard.

6. The electronic music instrument according to claim 1, further comprising an RGB LED for each key, the RGB LEDs being configured for color coding the indication of the desired root note and the desired scale.

7. The electronic music instrument according to claim 1, further comprising visual indicators each arranged at a key and configured for being adapted according to at least one parameter of the group of hue, saturation and brightness.

8. The electronic music instrument according to claim 1, wherein the keyboard is configured to be organized in sounding keys and non-sounding control keys and wherein the software module is configured for excluding control keys from being processed by play assistant functions and for excluding play assistant functions from generating control key signals.

9. The electronic music instrument according to claim 8, wherein the software module is configured for not discarding black keys assigned as control keys.

10. A method for controlling an electronic music instrument having a keyboard with a plurality of white keys and black keys configured for generating at least one digital signal corresponding to a particular note when pressed, wherein the note of the digital signal is remapped according to at least one of a desired root note and a desired scale and wherein digital signals generated by black keys are discarded.

11. The method according to claim 10, wherein at least one element of the group consisting of a desired root note and a desired scale can be visually indicated at a key.

12. The method according to claim 11, wherein the visual indication at a key is adaptable by at least one parameter of the group of hue, saturation and brightness.

13. The method according to claim 10, wherein an RGB LED is provided for each key and wherein an indication of the desired root note and the desired scale is color coded by the RGB LEDs.

14. The method according to claim 10, wherein control keys are excluded from play assistant functions.

15. The method according to claim 10, wherein black keys assigned as control keys are not discarded.

16. A computer program which enables a data processing device, after the computer program has been loaded into memory means of the data processing device, to carry out a method according to claim 10.

17. A computer-readable storage medium on which a program is stored which enables a data processing device, after the program has been loaded into memory means of the data processing device, to carry out a method according to claim 10.
